(19) United States
(12) Patent Application Publication
(10) Pub. No.: US 2025/0112973 A1
(43) Pub. Date: Apr. 3, 2025

(54) ROUTING OF 4G AND 5G SESSIONS

(71) Applicant: Oracle International Corporation, Redwood City, CA (US)

(72) Inventors: Rajiv Krishan, Cary, NC (US); Tukaram Maruti Khandekar, North Chelmsford, MA (US); Tarek Assali, Boston, MA (US); Geeta Mohanty, Bengaluru (IN)

(21) Appl. No.: 18/477,033

(22) Filed: Sep. 28, 2023

(51) Int. Cl. H04L 67/141

(52) U.S. Cl. CPC H04L 67/141

(57) ABSTRACT

Various embodiments of the present technology generally relate to systems and methods for routing messages for 4G and 5G sessions. In certain embodiments, a Policy and Charging Rules Function (PCRF) system may comprise one or more processors, and a memory having stored thereon instructions. The instructions, upon execution, may cause the one or more processors to receive a 4G communication session initiation request for a 4G session, and in response to the 4G communication session initiation request, issue a session binding request directed to a Binding Support Function (BSF), the session binding request directing the BSF to create a binding record linking the 4G session to the PCRF to enable routing of Application Function (AF) messages to the PCRF via the BSF. The instructions may further cause the one or more processors to receive an AF message routed to the PCRF based on the binding record.

### TECHNICAL FIELD

Various embodiments of the present technology generally relate to management of networks, such as fourth generation (4G) and fifth generation (5G) communications networks. More specifically, embodiments of the present technology relate to systems and methods for improved routing of messages within networks.

### BACKGROUND

In some communication network architectures (e.g., those using third generation partnership project, 3GPP standards), service may be implemented by establishing a user communication session, such as an IMS (IP Multimedia Subsystem) session or a PDU (packet data unit or protocol data unit) session. For example, user equipment (UE) may register with the network and trigger the creation of a session in order to setup IMS calls or PDU sessions for data exchange with the network. As part of the session creation process, a network function of the operator's network may be assigned to generate operator specific policy rules to control quality of service, charging, and other policies for the session. For an IMS call in 4G deployment, when a new AF (Application Function) session is being established and media information for this AF session is available at the AF, and when the related media requires PCC (Policy and Charging Control) supervision, the AF may open an Rx Diameter session with the PCRF (Policy and Charging Rules Function) for the AF session using an AA-Request command. In 5G deployment, an AF (supporting Diameter interface only) may open an Rx session with the PCF (Policy Control Function) for the AF session using an AA-Request command. To enable discovery of a PCF instance that has a specific corresponding N7 session context, 3GPP allows deploying a BSF (binding support function) that can be queried by an AF using an Nbsf_Management_Discovery Service Operation. The BSF network function assigned to the session can comprise information such as N7 session parameters, N7 endpoint, and Diameter identity for a PCF instance, and a session linked to a function in this manner may be referred to as a binding session.

In different network architectures, the network functions or other network components that trigger creation of a binding session, that are assigned to manage policies for a session, or that handle routing of messages regarding a session may be different. Similarly, message or interface protocols or standards used for the messages within different network architectures can differ. As an example, 4G EPC (evolved packet core) networks and 5GC (5G core) networks may utilize different network functions or components for management and routing of session messages.

For network operators, migrating from one architecture (e.g., 4G) to another (e.g., 5G) may take significant time. Users may use devices that only use one standard or another, and it may also take time to replace network infrastructure and components on the operator's end. However, some network functions or components (e.g., IMS network) may be shared among both standards. Accordingly, an operator may need to handle both 4G traffic and 5G traffic sessions, and may need to reliably and efficiently manage sessions and route messages across components of the different network architectures. However, there are shortcomings and gaps in the established network standards for managing routing across 4G and 5G environments. For example, an AF can use an Nbsf_Management_Discovery Service Operation to discover a PCF instance that has a corresponding 5G (N7) session, but due to a lack of 4G (Gx) session details at the BSF, an AF needs a fallback mechanism to route Gx sessions handled by PCRF deployments. This complicates AF logic to determine a context owner between PCRF (4G) or PCF (5G) instance, or to fail fast if a corresponding session does not exist in either 4G or 5G networks. Accordingly, there exists a need for improved routing of Rx session to corresponding PCRF and PCF instance in combined 4G and 5G deployment architecture.

The information provided in this section is presented as background information and serves only to assist in any understanding of the present disclosure. No determination has been made and no assertion is made as to whether any of the above might be applicable as prior art with regard to the present disclosure.

### BRIEF SUMMARY OF THE INVENTION

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments herein relate to systems, methods, and computer-readable storage media for performing configuration data management. In an embodiment, a Policy and Charging Rules Function (PCRF) system may comprise one or more processors, and a memory having stored thereon instructions. The instructions, upon execution, may cause the one or more processors to receive a 4G communication session initiation request for a 4G session, and in response to the 4G communication session initiation request, issue a session binding request directed to a Binding Support Function (BSF), the session binding request directing the BSF to create a binding record linking the 4G session to the PCRF to enable routing of Application Function (AF) messages to the PCRF via the BSF. The instructions may further cause the one or more processors to receive an AF message routed to the PCRF based on the binding record.

In some embodiments, the PCRF system may operate within a wireless network having the BSF configured to direct 4G AF messages to the PCRF and 5G AF messages to a policy control function (PCF). The PCRF system may receive the 4G communication session initiation request from a Packet Data Network Gateway (PGW). In some examples, the 4G communication session initiation request may include a Credit Control Request-initial (CCR-I) message. The PCRF system may receive the CCR-I message as a Gx interface message over a Diameter protocol. In some embodiments, the PCRF system may issue the session binding request as an Nbsf_Management_Register service operation request and may receive a response from the BSF including a bindingId corresponding to the binding record, and store the bindingId at the PCRF. In some examples, the PCRF system may receive a Credit Control Request-update (CCR-U) message from the PGW, and in response to receiving the CCR-U message, issue an Nbsf_Management_Update service operation request directed to the BSF, the Nbsf_Management_Update service operation request including the bindingId and directing the BSF to update the binding record. Similarly, the PCRF system may receive a Credit Control Request-terminate (CCR-T) message from the PGW, and in response to receiving the CCR-T message, issue an Nbsf_Management_Deregister service operation request directed to the BSF, the Nbsf_Management_Deregister service operation request including the bindingId and directing the BSF to deregister the binding record. In some examples, the AF message may include an Rx interface message.

In an alternative embodiment, a method may comprise operating a Policy and Charging Rules Function (PCRF) of a mobile network, including receiving a 4G communication session initiation request for a 4G session, and in response to the 4G communication session initiation request, issuing a session binding request to a Binding Support Function (BSF), the session binding request directing the BSF to create a binding record linking the 4G session to the PCRF to enable routing of Application Function (AF) messages to the PCRF via the BSF. The method may further include receiving an AF message routed to the PCRF based on the binding record.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein.

FIG. 1 is a diagram of a system configured to implement routing of 4G and 5G sessions, in accordance with certain embodiments of the present disclosure;

FIG. 2 is a diagram of a system configured to implement routing of 4G and 5G sessions, in accordance with certain embodiments of the present disclosure;

FIG. 3 is a diagram of a system configured to implement routing of 4G and 5G sessions, in accordance with certain embodiments of the present disclosure;

FIG. 4 is a chart of a system configured to implement routing of 4G and 5G sessions, in accordance with certain embodiments of the present disclosure;

FIG. 5 depicts a flow diagram of an example method to perform routing of 4G and 5G sessions, in accordance with certain embodiments of the present disclosure;

FIG. 6 depicts a flow diagram of an example method to perform routing of 4G and 5G sessions, in accordance with certain embodiments of the present disclosure;

FIG. 7 depicts a flow diagram of an example method to perform routing of 4G and 5G sessions, in accordance with certain embodiments of the present disclosure; and

FIG. 8 is a diagram of a system configured to implement routing of 4G and 5G sessions, in accordance with certain embodiments of the present disclosure.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In the following detailed description of certain embodiments, reference is made to the accompanying drawings which form a part hereof, and in which are shown by way of illustration of example embodiments. It is also to be understood that features of the embodiments and examples herein can be combined, exchanged, or removed, other embodiments may be utilized or created, and structural changes may be made without departing from the scope of the present disclosure. The following description and associated figures teach the best mode of the invention. For the purpose of teaching inventive principles, some aspects of the best mode may be simplified or omitted.

In accordance with various embodiments, the methods and functions described herein may be implemented as one or more software programs running on a computer processor or controller. Dedicated hardware implementations including, but not limited to, application specific integrated circuits, programmable logic arrays, and other hardware devices can likewise be constructed to implement the methods and functions described herein. Methods and functions may be performed by modules or nodes, which may include one or more physical components of a computing device (e.g., logic, circuits, processors, etc.) configured to perform a particular task or job, or may include instructions that, when executed, can cause a processor to perform a particular task or job, or any combination thereof. Further, the methods described herein may be implemented as a computer readable storage medium or memory device including instructions that, when executed, cause a processor to perform the methods.

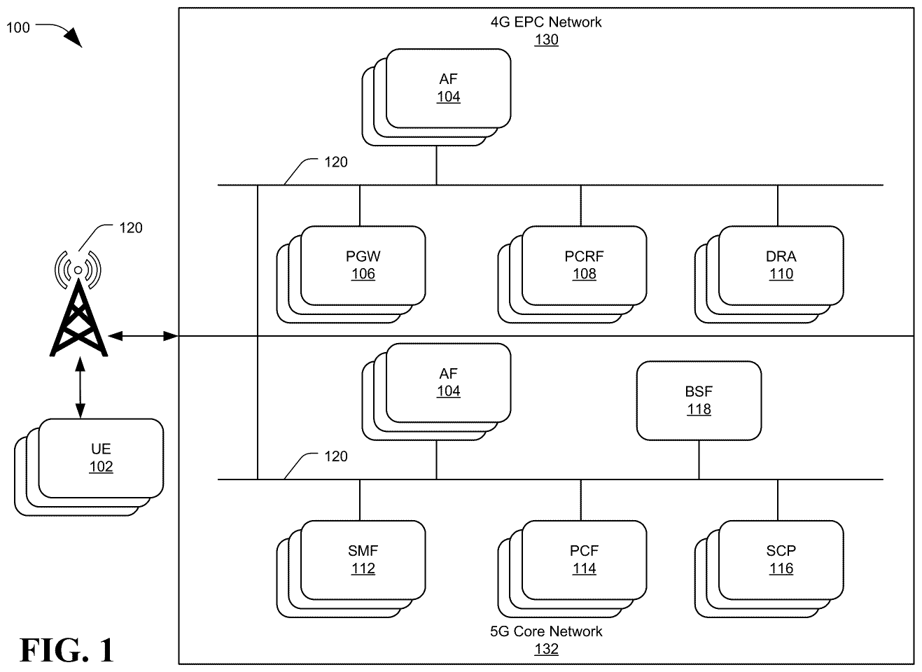

FIG. 1 is a diagram of a system 100 configured to implement routing of 4G and 5G sessions, in accordance with certain embodiments of the present disclosure. The example system 100 may include a mobile network implementing 3GPP (3rd Generation Partnership Project) communication standards (e.g., using the 23.503 technical specification (TS)), although the present disclosure may apply to other communication networks. In particular, the mobile network may include components and elements to implement a cellular network, which may include support for both a 4G EPC (evolved packet core) network 130 as well as a 5G Core (5GC or 5GS) network 132. The system 100 may include one or more user equipment (UE) 102 connected to 4G network 130 and 5G network 132 via network connectivity components 120.

Each or any of UE 102, 4G network 130 and its components, 5G network 132 and its components, and network 120 may be implemented via computers, servers, hardware and software modules, or other system components. The components of 4G network 130 and 5G network 132, or the physical devices implementing them, may be co-located, remotely distributed, or any combination thereof. The elements of system 100 may include components hosted or situated in the cloud and/or implemented as software modules potentially distributed across one or more server devices or other physical components.

UE 102 may be a device, system, or module that may utilize the resources of the 4G network 130 or 5G network 132, such as to establish communications with another UE. Communication sessions may include but are not limited to IMS calls (Internet Protocol Multimedia subsystem), other cell phone calls, internet or other data connections, or any and all other types of communications sessions over 4G or 5G networks. UE 102 may include devices such as cell phones, tablets, modems, vehicles, desktop or laptop computers, televisions or set-top boxes, smart home devices, voice over IP (VOIP) devices, internet of things (IoT) devices, or any and all other systems that may utilize a cellular network.

Network connectivity components 120 may provide communication paths between UE 102, 4G network 130, and 5G network 132. Network connectivity components 120 may comprise components that enable communication over communication links, such as network cards, ports, radio frequency (RF) modules, telecommunications channels, cell towers, switches, routers, processing circuitry and software, or other communication components. Network connectivity components 120 may include metallic, wireless, cellular, or optical links, using various communication formats and protocols. In some examples, network connectivity components 120 may simply be referred to as a “network” by which systems or modules are connected or communicate.

The 4G network 130 and 5G network 132 may each include part of a mobile communications network that provides services to UEs 102 through the network connectivity components 120. Each of 4G network 130 and 5G network 132 may include a plurality of components, modules, or network functions (NFs) configured to provide mobile communication services via the corresponding 4G EPC or 5G Core communications protocols. Some components of 4G network 130 may be configured to communicate and operate with components of 5G network 132 and vice-versa in servicing 4G and 5G communications sessions, while other components may not be configured to communicate across the protocol divide.

4G EPC network 130 may include an application function (AF) 104, packet data network gateway (PGW) 106, policy and charging rules function (PCRF) 108, and diameter routing agent (DRA) 110. The AF 104 may be configured to manage and provide application services to subscribers and UEs 102. AF 104 may interact with the PCRF 108 to manage properties of communication sessions for various resources. PGW 106 may operate as an ingress and egress point into the 4G EPC network 130 for communications with UE 102 or other packet data networks (PDNs) such as the internet, and may manage session establishment, modification, and termination. The PGW 106 may act as an anchor between 3GPP and non-3GPP technologies. PCRF 108 may be configured to determine policy rules in the 4G network 130. For example, a UE 102 may be associated with a user account or subscription having certain parameters (e.g., data or rate limits, quality of service, pricing, etc.). The PCRF 108 may manage the service provided by 4G network 130 for a subscriber session established by a UE 102. Accordingly, a communication session for a UE 102 may be associated with a particular PCRF 108. A DRA 110 may provide real-time routing capabilities to ensure that messages are routed among the correct elements in a network. The DRA 110 may operate with Diameter communications, where Diameter is an authentication, authorization, and accounting (AAA) protocol for Long-Term Evolution (LTE) and IMS networks, and that runs over TCP (transmission control protocol).

5G core network 132 may include AF 104, session management function (SMF) 112, policy control function (PCF) 114, service controller or communications proxy (SCP) 116, and binding support function (BSF) 118. 5G core network 132 may include AF 104 instead of or in addition to the AF in 4G network 130. The AF 104 in 5G network 132 may serve a similar purpose to that described for 4G network 130, but may interact with PCF 114 instead of PCRF 108. For ease of discussion, references to AF may refer to those in either 4G network 130 or 5G network 132 unless otherwise specified. 5G network 132 may also include SMF 112, configured to handle session establishment, modification, and release. PCF 114 may be assigned to a subscriber session (e.g., a PDU session) created when a UE 102 registers with the 5G network 132. The PCF 114 may generate policy rules for the session to control quality of service and charging for the session, and may register the session with the BSF 118. BSF 118 may maintain a list, database, or other data structure of binding records describing which PCF 114 is assigned to a subscriber session. The BSF 118 may provide the binding support management service (Nbsf_Management service), allowing the BSF to provide session binding functionality, which can ensure that an AF 104 request for a certain session can reach the relevant PCF 114 having the session information. The BSF 118 may create a binding record when a PCF 114 registers a session with BSF 110. AF 104 seeking to discover the session binding for a UE 102 may do so by querying the BSF 118 using a discovery application programming interface (API) provided by the BSF. The BSF 118 may delete binding records in response to a delete binding record request from a PCF 114. SCP 116 may perform signal routing and load balancing, enabling dynamic scaling and management of communication services for HTTP (hypertext transfer protocol) traffic in the 5G network 132.

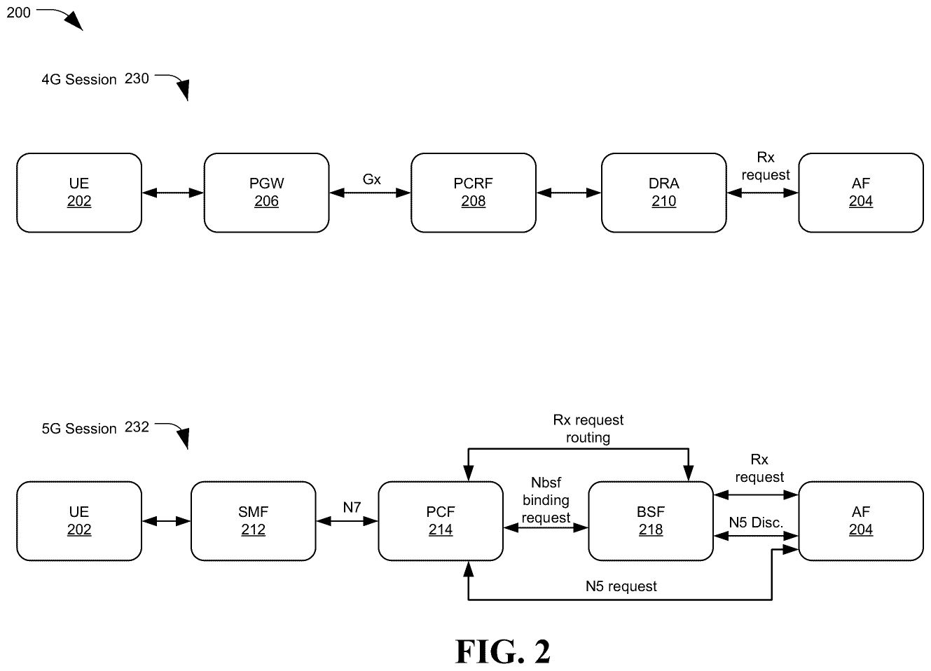

Network operators servicing both 4G and 5G calls may not completely segregate their networks into two distinct systems and may share services and functionality across 4G network 130 and 5G network 132. However, routing and management of session messages can be difficult in such systems, because 4G sessions may be associated with a particular PCRF 108, and 5G sessions may be associated with a particular PCF 114, and the components by which session bindings are tracked and messages routed may be different across network protocols. The establishment and routing of messages for binding sessions in different protocols is discussed in regard to FIG. 2.

FIG. 2 is a diagram of a system 200 configured to implement routing of 4G and 5G sessions, in accordance with certain embodiments of the present disclosure. In particular, the example system 200 may depict a 4G communication session 230, and a 5G communication session 232. The session diagrams provide example simplified processes by which a subscriber session is established and managed, and the different components involved between 4G and 5G protocols. Not all components and data exchanges may be depicted. The system of FIG. 2 may be implemented by the components described in regard to system 100 of FIG. 1.

Referring now to the 4G session 230, a UE 202 may connect to a 4G network by initiating a communications session. The UE 202 may connect to the network via the PGW 206. In response to the connection, the PGW 206 may set up a session with PCRF 208. The session setup may use the Gx interface protocol, where messages are part of the Diameter protocol used in 4G architectures. Accordingly, a 4G session may be referred to as a Gx session. The PCRF 208 can set up the properties to configure and manage the session. An AF 204 may discover the PCRF 208 associated with a given session via a DRA 210. The DRA 210 may store data necessary for routing messages, for example based on subscriber information included with the message from the AF 204. In an embodiment, a DRA 210 may route messages to different PCRFs 208 based on IP ranges associated with UEs 202. The AF 204 may send messages via the Rx interface protocol, which like Gx messages, are part of the Diameter protocol. The DRA 210 may route the Rx message to the corresponding PCRF 208 for the session.

Referring now to the 5G session 232, a UE 202 may connect to a 5G network by initiating a communications session. The UE 202 may connect to the network via the SMF 212. The SMF 212 may then set up a session with PCF 214 using an N7 interface protocol. The N7 interface is a communication protocol used in 5G over HTTP. Accordingly, a 5G session may be referred to as an N7 session. The PCF 214 may issue a binding request to BSF 218 using the Nbsf (NF biding support function) protocol, establishing that the particular PCF 214 is associated with the session for the particular UE 202.

The AF 204 may query the BSF 218 for the binding information associated with the session. The process flow may differ depending on whether the message flow is for an N5 message or an Rx message. Rx messages may be used within a 5G network as well as within a 4G network, for example to handle IMS calls.

N5 messages may be sent via the N5 interface protocol which, like N7 messages, are HTTP messages used within the 5G network. For N5 messages, the AF 204 may first send a discovery request to the BSF 218 to determine the PCF 214 associated with the communication session. Based on the results of the discovery request, the AF 204 may then route the N5 request to the corresponding PCF 214 via the N5 interface protocol.

For Rx requests, the AF 204 may send the Rx request to the BSF 218. The BSF 218 may look up the binding record to determine a PCF 214 associated with the communication session, and then may act as a proxy or forwarder to automatically forward the Rx message to the appropriate PCF 214. Alternately, the AF may perform a discovery request to the BSF 218, receive a response, and then the AF 204 may forward the Rx message to the appropriate PCF 214 based on the response.

Gx and N7 messages may be equivalent across 4G and 5G networks, respectively, for establishing sessions. Similarly, Rx and N5 messages may be handled similarly for allocating and managing data resources for a session. Likewise, PCRF 208 and PCF 214 perform similar functionality in 4G and 5G networks respectively. BSF 218 provides useful session binding information, but under 3GPP is only configured to operate for N7 sessions. Using DRA 210 for routing messages, for 4G traffic, has its own limitations.

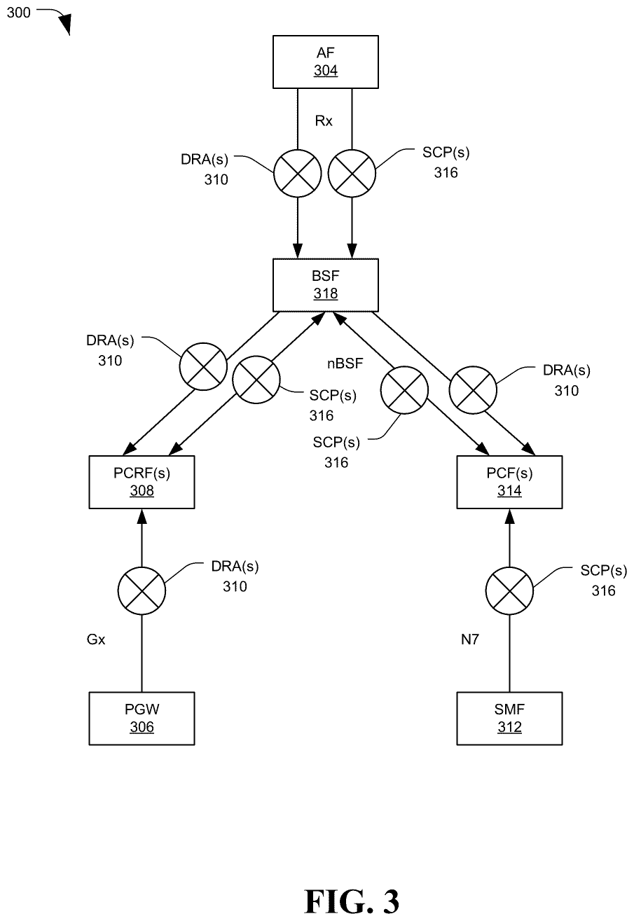

Difficulties may arise when operating a converged network for both 4G and 5G traffic. In an example AF 204 may be used to manage resources for both 4G and 5G sessions. 3GPP TS 23.503 describes that both DRA 210 and BSF 218 can coexist in a network. AF 204 would send Rx messages to a DRA 210, which would potentially route traffic to an appropriate PCRF 208, or if it has no biding information for a subscriber, the DRA may query the BSF 218 for a relevant PCF 214 address. However, shortcomings exist with this setup. In a distributed deployment model, there may be multiple DRA 210 instances without shared binding context, and so may not know what PCRF 208 to route a particular session to. BSF 218 may only have binding information for N7 sessions created by PCF 214. Accordingly, DRAs 210 may not know how to appropriately route some 4G traffic. Additionally, 3GPP allows IP preservation between EPC to 5G, which means even when DRA is present, an operator cannot use any static routing rules on DRA for Rx routing between PCRF vs PCF. Accordingly, FIG. 3 provides an improved implementation of 4G and 5G routing.

FIG. 3 is a diagram of a system 300 configured to implement routing of 4G and 5G sessions, in accordance with certain embodiments of the present disclosure. In particular, the example system 300 may depict a converged mobile communications network supporting both 4G and 5G communications. The system 300 may be implemented by the components described in regard to system 100 of FIG. 1 and system 200 of FIG. 2.

As described in regard to FIG. 2, SMF 312 may initiate a 5G session via an N7 message to PCF 314. According to 3GPP protocols, the N7 initiation trigger may take the form of an Npcf_SMPolicyControl_Create service operation from the SMF 312 to the PCF 314. HTTP messages may be routed via SCP 316, while Diameter messages may be routed via DRA 310. As N7 messages may be HTTP messages, they may be routed via SCP 316. PCF 314, in response to the trigger, may create and submit a session binding request to BSF 318 via an Nbsf protocol message (e.g., Nbsf_Management_Register service operation). As Nbsf messages are also HTTP-based, this message may once again be routed via an SCP 316. Based on the requested service operation, the BSF 318 may update the session binding records to register the binding session. The BSF 318 may also return a response to the PCF 314 (e.g., via SCP 316) indicating whether a binding recording has been created, and if so, providing the PCF with a “bindingId” for the session. The PCF 314 may store a copy of the bindingId, which it may use for updates or termination of the binding record.

For the establishment of a 4G session, the PGW 306 may initiate the session via a Gx message to PCRF 308. The Gx initiation trigger may take the form of a CCR-I (credit control request-initial) message from the PGW 306 to the PCRF 308. This Diameter protocol message may be routed via DRA 310. In the depicted embodiment, PCRF 308 may be configured to use the Nbsf interface to create and delete Gx session bindings via the BSF 318. The PCRF 308 may create and submit a session binding request to BSF 318 via an Nbsf protocol message (e.g., Nbsf_Management_Register service operation), just as PCF 314 does for 5G sessions. The request may be routed via SCP 316. The BSF 318 may respond to the request as it would to a request from a PCF 314, and update the session binding records to reflect PCRF 308 as the function associated with the 4G session. The BSF 318 may return a response to the PCRF 308 (e.g, via SCP 316) indicating whether a binding recording has been created, and if so, providing the PCRF with a “bindingId” for the session. The PCRF 308 may store a copy of the bindingId, which it may use for updates or termination of the binding record. Issuing a binding request from PCRF 308 to BSF 318 enables the BSF to route Rx sessions to PCRFs as well as PCFs, thereby improving converged network operations.

Under the depicted embodiment, an AF 304 in a converged network may issue Rx session messages (e.g., for IMS calls), whether for 4G or 5G sessions, and route them to the BSF 318 (e.g., potentially via DRA 310). Rather than AF 304 or DRA 310 (between AF 304 and BSF 318) having complexity and routing logic to handle 4G or 5G sessions differently, AF 304 or DRA 310 can either query BSF 318 (e.g., through an Nbsf_Management_Discovery service operation) for session ownership between PCF 314 or PCRF 308 and then route to the Rx message to the appropriate function, or route all Rx messages to BSF 318, which may forward the Rx message to the appropriate PCF 314 or PCRF 308. There are a number of ways of implementing the querying of the BSF 318 by the AF 304 or DRA 310, and routing the Rx message. For example, the AF may query the BSF 318 via an SCP 316, and then route the Rx request to the appropriate PCF 314 or PCRF 308. In another example, the AF 304 may send an Rx request to the DRA 310, which may either forward the Rx request to the BSF 318, where the BSF can forward the Rx request to the appropriate PCF 314 or PCRF 308, or the DRA may query the BSF 318, and then route the Rx request based on the query response. It may be noted that 3gpp specifications allow for DRAs 310 to send an Nbsf_Management_Discovery service operation to BSF 318, even though DRAs 310 typically handle Diameter protocol communications and Nbsf communications include HTTP protocol communications. It may also be noted that instances of DRAs 310 and SCPs 316 are optional, and messaging may be managed in a network without these components.

The process of the AF 304 or DRA 310 being able to query the BSF 318 for all 4G and 5G Rx communications may simplify IP routing and segregation operations for 4G and 5G, and eliminate problems with multiple DRAs each having incomplete routing or binding information. The BSF 318 may route or forward Rx messages via DRAs 310 regardless of whether the message is for a 4G or 5G session.

It may be noted that managing bindings with BSF 318 may be better accomplished via the PCRF 308 than via a DRA 310, such as the DRA between PGW 306 and PCRF 308. Message routing from PGW 306 to PCRF 308 may not always be through a same DRA 310 instance. For example, the DRA 310 handling an initial CCR-I from PGW 306 to PCRF 308 may not be the same DRA available during a CCR-T (credit control request-terminate) or CCR-U (credit control request-update) message flow. To delete a binding record at BSF 318, a “bindingId” may be required, which the BSF may provide upon initial creation of a binding record. Thus, any DRA 310 handing a CCR-T must have the “bindingId” available to delete the corresponding binding record from BSF 318. If the DRA 310 used to delete the binding is not the same one that was used to create the binding and possesses the bindingId, the deletion may fail. Accordingly, the PCRF 308, which may stay consistent throughout the binding lifespan, may be a superior module to create and manage the binding.

Similar to PCF 314, PCRF 308 may not be required to create a binding for every APN (Access Point Name). It may employ a configurable list of APNs that require Rx flow, for which bindings shall be created at BSF 318.

Binding creation, update, and deletion rules in regard to the BSF 318 may be configured the same for PCRF 308 as those defined by 3gpp for PCF 314. However, the trigger messages, and the information provided from PCRF 308 to BSF 318 may be different from PCF 314. The trigger messages to invoke a binding creation request are depicted in table 1:

TABLE 1

| | PCRF trigger | BSF service operation |
|---|---|---|
| PCF trigger (N7 message) | (Gx message) | invoked (Nbsf) |
| Npcf_SMPolicyControl_ | CCR-Initial | Nbsf_Management_Register |
| Create Service Operation | | Service Operation |
| Npcf_SMPolicyControl_ | CCR-Update | Nbsf_Management_Update |
| Update Service Operation | | Service Operation |
| Npcf_SMPolicyControl_ | CCR-Terminate | Nbsf_Management_ |
| Delete Service Operation | | Deregister Service Operation |

Although the 3GPP specification may specify that the Nbsf_Management_Register service operation causes a BSF 318 to register a new PCF 314 for a PDU session binding information, the same functionality can cause the BSF to register a PCRF 308 for a 4G session. In some examples, the BSF 318 may not differentiate between a PCF 314 and a PCRF 308, nor between a 5G session and a 4G session.

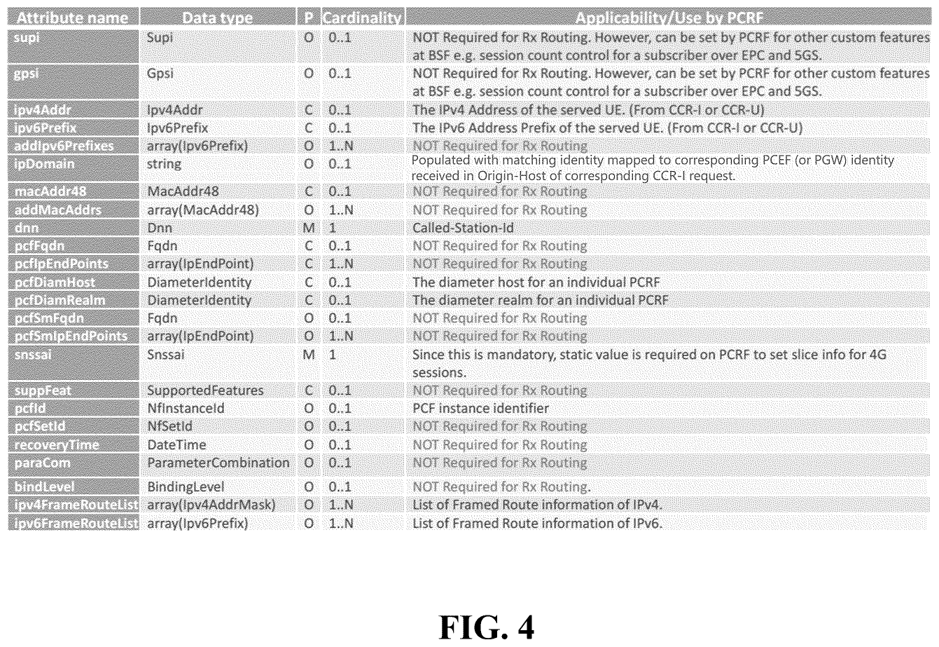

Similar, some attributes that a PCF 314 may supply to BSF 318 during binding creation may be optional, and such attribute information would not need to be acquired or transmitted by PCRF 308. For example, addIpv6Prefixes, macAddr48, pcfFqdn, pcfSmFqdn, suppFeat, pcfSetId, and other non-mandatory attributes or parameters can be excluded from a binding create request. See FIG. 4 for an example chart of attributes, and how they may be used or ignored by PCRF 308 in binding creation. Only minimum parameters may be required to enable Rx session routing from BSF 318 to PCRF 308.

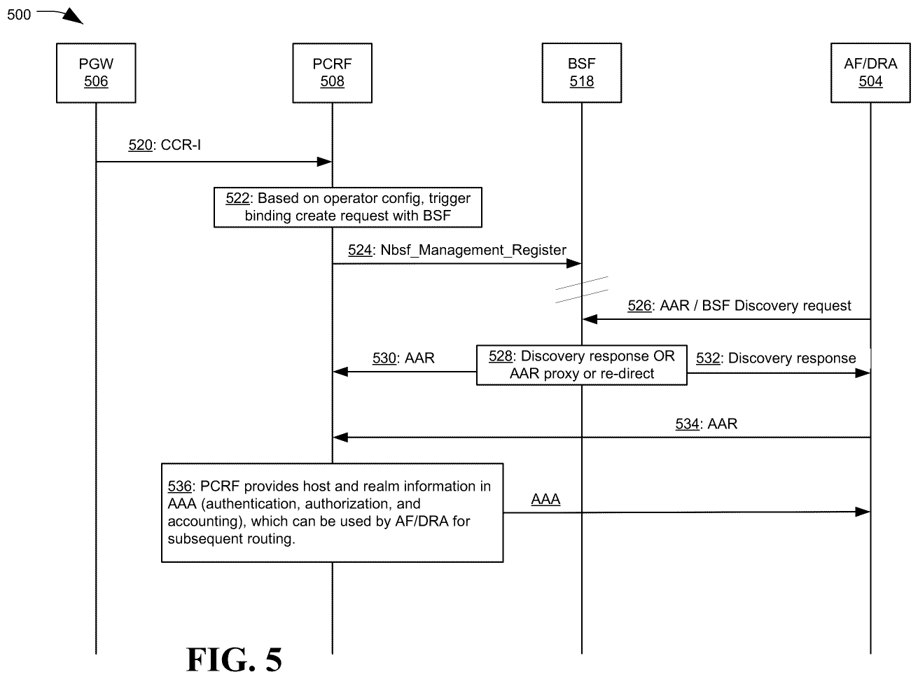

Returning to FIG. 3, as described above the example converged routing system may provide a number of benefits or advantages. It may allow any DRA 310 or AF 304 to route Rx sessions correctly to corresponding PCRF 308 or PCF 314 based on binding data at BSF 318. It may allow multiple DRAs 310 to remain stateless from binding context management. It may allow network operators to enable BSF 318 to be an anchor point for strict session count enforcement on number of sessions for a user, domain, or APN. For example, a single subscriber or user may be limited to a single active session, but without BSF 318 as a centralized entity for maintaining sessions, a user may have one active 4G session and one active 5G session. When all the sessions are being stored at the BSF 318, an operator can write custom features in BSF to enforce a rule that only one session should exist on a given IP domain or APN. As another benefit, BSF 318 may not need to differentiate between binding sessions created by PCF 314 or PCRF 308, and thus, no changes may be required for BSF 318. Additionally, since 3GPP allows DRA 310 to query BSF 318 for routing, the same security considerations for DRA can be applied for PCRF 308 when connecting BSF. Further, BSF 318 can proxy or redirect Rx requests targeting an IP address of a UE to the selected PCRF 308. The ability to proxy or redirect requests from BSF 318 to PCF 314 is described in TS 23.503 Annex C, and can likewise be applied for PCRF 308. In other words, rather than an AF 304 or DRA 310 querying the BSF 318 for an address, and then having the AF or DRA send the Rx session request to the provided address, the AF or DRA can send the Rx session request to the BSF, and the BSF will determine the address and forward the message directly to the PCF 314 or PCRF 308, saving process steps and network traffic. An example process flow diagram for session binding and routing is shown in FIG. 5.

FIG. 5 depicts a flow diagram 500 of an example method to perform routing of 4G and 5G sessions, in accordance with certain embodiments of the present disclosure. In particular, diagram 500 depicts an initial Gx session binding creation, and Rx session routing. Diagram 500 depicts an example message flow between a PGW (packet data network gateway) 506, PCRF (policy and charging rules function) 508, BSF (binding support function) 518, and AF (application function) or DRA (Diameter routing agent) 504. The components in diagram 500 may correspond to elements described in regard to FIG. 3.

PGW 506 may send a credit control request-initial (CCR-I) message 520 to PCRF 508, for example in response to a subscriber logging in, or a UE initiating a call or data connection. The CCR-I 520 may initiate a Gx session, and may include one or more attributes or property values about the Gx session that the PCRF 508 may use to establish a session binding.

At 522, based on operator configuration of the PCRF 508, receipt of the CCR-I 520 may trigger the PCRF to generate and submit a session binding create request to the BSF 518. The PCRF 508 may use the Nbsf interface to submit a Nbsf_Management_Register service operation request 524 to the BSF 518. The Nbsf_Management_Register request 524 may include attributes (e.g., from FIG. 4) that can be used to register a PCRF 508 with a binding session. The BSF 518 in turn may create the session binding record information to indicate that the session is associated with PCRF 508, and may provide the PCRF with binding resource information for use in subsequent operations. PCRF 508 may store the binding resource information, along with Gx session data.

At a future point, AF or DRA 504 may send an authorization and authentication request (AAR) 526 to BSF 518. An AAR request may be a Diameter message used in the PCC (policy and charging control) framework which allows an AF 504 to supply session-related information to the PCRF 508, and may be an example of an Rx message. Alternately, AF or DRA 504 may send a BSF discovery request 526 towards BSF 518, requesting an address for a PCF or PCRF associated with a subscriber session.

In response to the AAR or BSF discovery request 526, the BSF 518 may access the binding information it maintains to determine the PCRF 508 associated with the specified session, and prepare a discovery response or redirect, at 528. If the AF or DRA 504 sent an AAR 526, then BSF 518 may operate as a redirect agent or proxy, and can forward the AAR 530 to the corresponding PCRF 508.

If the AF or DRA 504 issued a discovery request 526 instead of an AAR, the BSF 518 may return a discovery response 532 including IP or other addressing information for the PCRF 508. The AF or DRA 504 may then use the addressing information to perform the message routing and send the AAR 534 to the target PCRF 508.

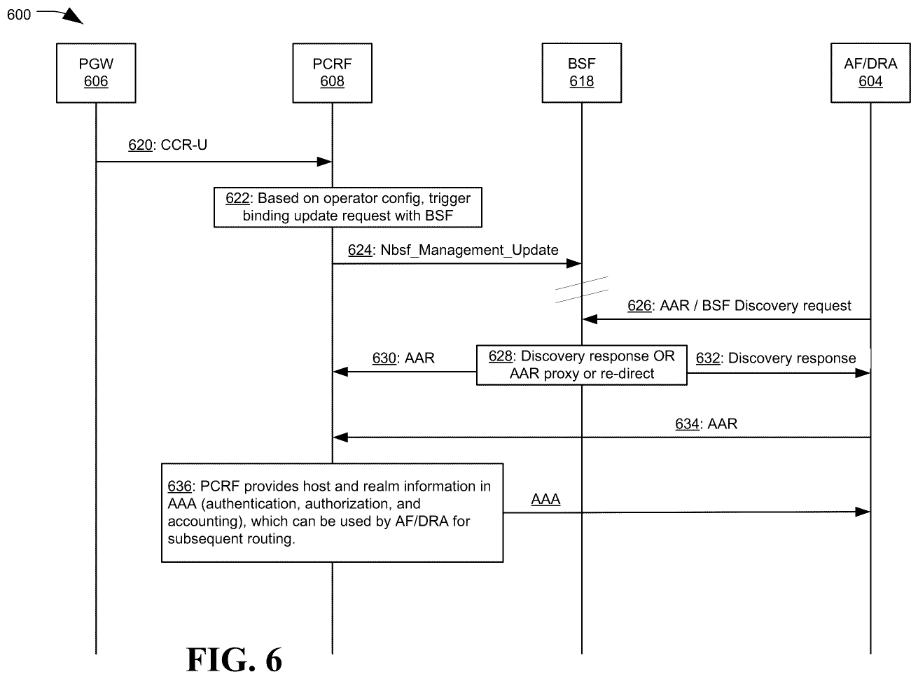

At 536, the PCRF 508 may receive the AAR 530 forwarded from the BSF 518, or the AAR 534 sent from the AF or DRA 504. In response, the PCRF 508 may provide host and realm information in an AAA (authentication, authorization, and accounting) message, which can be used by AF or DRA 504 for subsequent routing. A process flow for a binding update is shown in FIG. 6.

FIG. 6 depicts a flow diagram 600 of an example method to perform routing of 4G and 5G sessions, in accordance with certain embodiments of the present disclosure. In particular, diagram 600 depicts an update process for a Gx session, and Rx session routing based on the updated binding. Diagram 600 depicts an example message flow between a PGW (packet data network gateway) 606, PCRF (policy and charging rules function) 608, BSF (binding support function) 618, and AF (application function) or DRA (Diameter routing agent) 604. The components in diagram 600 may correspond to elements described in regard to FIG. 3 and FIG. 5.

PGW 606 may send a credit control request-update (CCR-U) message 620 to PCRF 608. In an example use case, a CCR-U message may be sent when a request to establish or terminate an IP-CAN (IP-Connectivity Access Network) bearer occurs, when a request for resource modification occurs, or when an Event trigger is met. The CCR-U message may be an update for an existing or established Gx session for which a binding has already been created at the BSF 618.

At 622, based on operator configuration of the PCRF 508, receipt of the CCR-U 620 may trigger the PCRF to generate and submit a session binding update request to the BSF 618. The PCRF 608 may use the Nbsf interface to submit a Nbsf_Management_Update service operation request 624 to the BSF 618. For binding update, PCRF may use the binding resource provided by BSF 618 during the binding registration process, as shown at 524 of FIG. 5. The BSF 618 in turn may update the session binding information for the session with the updated parameters.

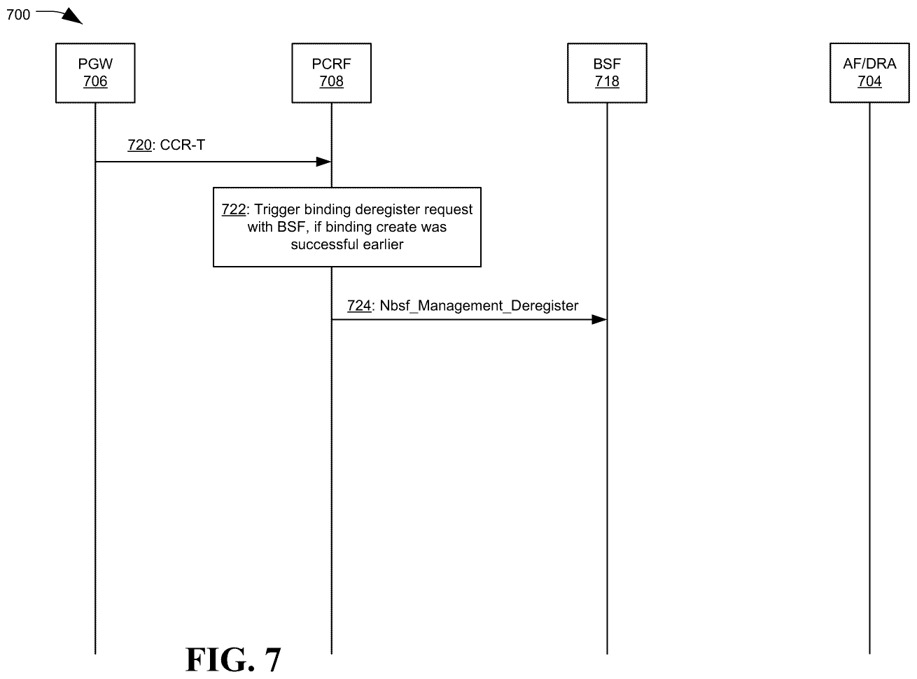

At a future point, AF or DRA 604 may send an authorization and authentication request (AAR) or BSF discovery request 626 to BSF 618. In turn, the BSF 618 may provide a discovery response or AAR proxy or re-direct based on the updated binding, at 628. The forwarded AAR 630, or the discovery response 632 and AF/DRA 604-routed AAR 634, and the AAA response from the PCRF at 636, may operate as described in regard to FIG. 5. A process flow for deregistering or deleting a binding is shown in FIG. 7.

FIG. 7 depicts a flow diagram 700 of an example method to perform routing of 4G and 5G sessions, in accordance with certain embodiments of the present disclosure. In particular, diagram 700 depicts a terminate, de-register, or delete process for a Gx session binding. Diagram 700 depicts an example message flow including a PGW (packet data network gateway) 706, PCRF (policy and charging rules function) 708, BSF (binding support function) 718, and AF (application function) or DRA (Diameter routing agent) 704. The components in diagram 700 may correspond to elements described in regard to FIG. 3, FIG. 5, and FIG. 6.

PGW 706 may send a credit control request-terminate (CCR-T) message 720 to PCRF 708. A termination request 720 may be sent to PCRF 708 when the IP-CAN session is being terminated. The CCR-T message 720 may be a request to remove or de-register an existing or established Gx session for which a binding has already been created at the BSF 718.

At 722, receipt of the CCR-T 720 may trigger the PCRF 708 to generate and submit a session binding deregister request to the BSF 718 regarding an earlier successful binding creation. The PCRF 708 may use the Nbsf interface to submit a Nbsf_Management_Deregister service operation request 724 to the BSF 718. For deregistration, PCRF may use the binding resource provided by BSF 718 during the binding registration process, as shown at 524 of FIG. 5. The BSF 718 in turn may deregister or delete the session binding information for the session based on the deregister request.

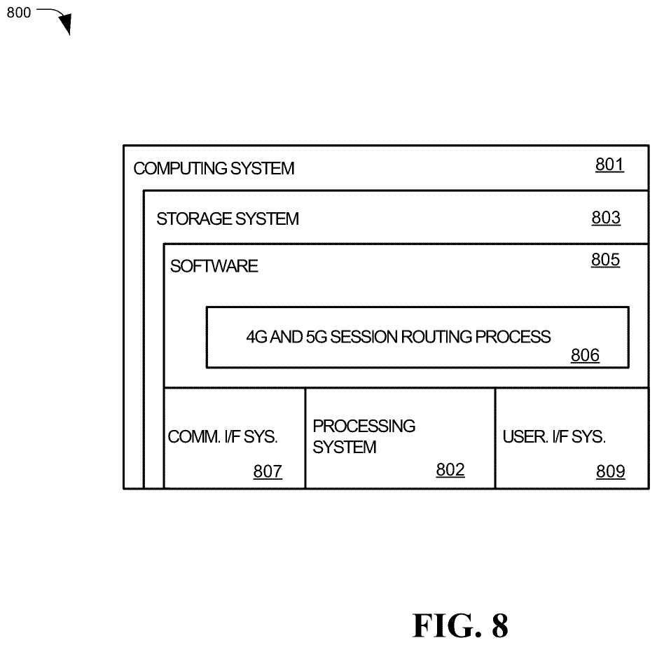

At this point, the binding record for the session may have been removed or deactivated at the BSF 718. Any future requests from the AF or DRA 704 regarding the deregistered binding may fail or receive an indication that the requested binding is not found or not active. A computing system configured to perform the operations and methods described herein is provided in regard to FIG. 8.

FIG. 8 is a diagram of a system 800 configured to implement routing of 4G and 5G sessions, in accordance with certain embodiments of the present disclosure. System 800 may be an example of an apparatus including a computing system 801 that is representative of any system or collection of systems in which the various processes, systems, programs, services, and scenarios disclosed herein may be implemented. For example, computing system 801 may be an example user equipment 102, network connectivity components 120, 4G EPC network 130, 5G Core network 132, or any of the subcomponents depicted in system 100 of FIG. 1. Examples of computing system 801 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing system 801 may be implemented as a single apparatus, system, or device or may be implemented in a distributed manner as multiple apparatuses, systems, or devices. Computing system 801 may include, but is not limited to, processing system 802, storage system 803, software 805, communication interface system 807, and user interface system 809. Processing system 802 may be operatively coupled with storage system 803, communication interface system 807, and user interface system 809.

Processing system 802 may load and execute software 805 from storage system 803. Software 805 may include and implement 4G and 5G session routing process 806, which may be representative of any of the operations implementing a hybrid or converged network of 4G and 5G communications, and of routing session messages therefore, as discussed with respect to the preceding figures. When executed by processing system 802, software 805 may direct processing system 802 to operate as described herein for at least the various processes, operational scenarios, and sequences discussed in the foregoing implementations. Computing system 801 may optionally include additional devices, features, or functionality not discussed for purposes of brevity.

In some embodiments, processing system 802 may comprise a micro-processor and other circuitry that retrieves and executes software 805 from storage system 803. Processing system 802 may be implemented within a single processing device but may also be distributed across multiple processing devices or sub-systems that cooperate in executing program instructions. Examples of processing system 802 may include general purpose central processing units, graphical processing units, application specific processors, and logic devices, as well as any other type of processing device, combinations, or variations thereof.

Storage system 803 may comprise any memory device or computer readable storage media readable by processing system 802 and capable of storing software 805. Storage system 803 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 803 may also include computer readable communication media over which at least some of software 805 may be communicated internally or externally. Storage system 803 may be implemented as a single storage device but may also be implemented across multiple storage devices or sub-systems co-located or distributed relative to each other. Storage system 803 may comprise additional elements, such as a controller, capable of communicating with processing system 802 or possibly other systems.

Software 805 (including 4G and 5G session routing process 806 among other functions) may be implemented in program instructions that may, when executed by processing system 802, direct processing system 802 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 805 may include additional processes, programs, or components, such as operating system software, virtualization software, or other application software. Software 805 may also comprise firmware or some other form of machine-readable processing instructions executable by processing system 802.

In general, software 805 may, when loaded into processing system 802 and executed, transform a suitable apparatus, system, or device (of which computing system 801 is representative) overall from a general-purpose computing system into a special-purpose computing system as described herein. Indeed, encoding software 805 on storage system 803 may transform the physical structure of storage system 803. The specific transformation of the physical structure may depend on various factors in different implementations of this description. Examples of such factors may include, but are not limited to, the technology used to implement the storage media of storage system 803 and whether the computer-storage media are characterized as primary or secondary storage, as well as other factors.

For example, if the computer readable storage media are implemented as semiconductor-based memory, software 805 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 807 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between computing system 801 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer readable medium(s) having computer readable program code embodied thereon.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

1. A Policy and Charging Rules Function (PCRF) system, comprising:
one or more processors; and
a memory having stored thereon instructions that, upon execution by the one or more processors, cause the one or more processors to:
receive a 4G communication session initiation request for a 4G session;
in response to the 4G communication session initiation request, issue a session binding request directed to a Binding Support Function (BSF), the session binding request directing the BSF to create a binding record linking the 4G session to the PCRF to enable routing of Application Function (AF) messages to the PCRF via the BSF; and
receive an AF message routed to the PCRF based on the binding record.

2. The PCRF system of claim 1, wherein the PCRF operates within a wireless network having the BSF configured to direct 4G AF messages to the PCRF system and 5G AF messages to a policy control function (PCF).

3. The PCRF system of claim 2, wherein the instructions comprise further instructions that, upon execution by the one or more processors, cause the one or more processors to:
receive the 4G communication session initiation request from a Packet Data Network Gateway (PGW).

4. The PCRF system of claim 3, wherein the 4G communication session initiation request includes a Credit Control Request-initial (CCR-I) message.

5. The PCRF system of claim 4, wherein the instructions comprise further instructions that, upon execution by the one or more processors, cause the one or more processors to:
receive the CCR-I message as a Gx interface message over a Diameter protocol.

6. The PCRF system of claim 5, wherein the instructions comprise further instructions that, upon execution by the one or more processors, cause the one or more processors to:
issue the session binding request as an Nbsf_Management_Register service operation request.

7. The PCRF system of claim 6, wherein the instructions comprise further instructions that, upon execution by the one or more processors, cause the one or more processors to:
receive a response from the BSF including a bindingId corresponding to the binding record; and
store the bindingId at the PCRF.

8. The PCRF system of claim 7, wherein the instructions comprise further instructions that, upon execution by the one or more processors, cause the one or more processors to:
receive a Credit Control Request-update (CCR-U) message from the PGW; and
in response to receiving the CCR-U message, issue an Nbsf_Management_Update service operation request directed to the BSF, the Nbsf_Management_Update service operation request including the bindingId and directing the BSF to update the binding record.

9. The PCRF system of claim 8, wherein the instructions comprise further instructions that, upon execution by the one or more processors, cause the one or more processors to:
receive a Credit Control Request-terminate (CCR-T) message from the PGW; and
in response to receiving the CCR-T message, issue an Nbsf_Management_Deregister service operation request directed to the BSF, the Nbsf_Management_Deregister service operation request including the bindingId and directing the BSF to deregister the binding record.

10. The PCRF system of claim 9, wherein the AF message includes an Rx interface message.

11. A method comprising:
operating a Policy and Charging Rules Function (PCRF) of a mobile network, including:
receiving a 4G communication session initiation request for a 4G session;
in response to the 4G communication session initiation request, issuing a session binding request directed to a Binding Support Function (BSF), the session binding request directing the BSF to create a binding record linking the 4G session to the PCRF to enable routing of Application Function (AF) messages to the PCRF via the BSF; and
receiving an AF message routed to the PCRF based on the binding record.

12. The method of claim 11 further comprising:
operating the PCRF within a wireless network having the BSF configured to direct 4G AF messages to the PCRF and 5G AF messages to a policy control function (PCF).

13. The method of claim 11, further comprising:
receiving the 4G communication session initiation request from a Packet Data Network Gateway (PGW).

14. The method of claim 11, further comprising:
issuing the session binding request as an Nbsf_Management_Register service operation request;
receiving a response from the BSF including a bindingId corresponding to the binding record; and
storing the bindingId at the PCRF.

15. The method of claim 14, wherein the 4G communication session initiation request includes a Credit Control Request-initial (CCR-I) message.

16. The method of claim 15, further comprising:
receiving a Credit Control Request-update (CCR-U) message; and
in response to receiving the CCR-U message, issuing an Nbsf_Management_Update service operation request directed to the BSF, the Nbsf_Management_Update service operation request directing the BSF to update the binding record.

17. The method of claim 15, further comprising:
receiving a Credit Control Request-terminate (CCR-T) message; and
in response to receiving the CCR-T message, issuing an Nbsf_Management_Deregister service operation request directed to the BSF, the Nbsf_Management_Deregister service operation request directing the BSF to deregister the binding record.

18. The method of claim 11, wherein the AF message includes an Rx interface message.

19. The method of claim 18, further comprising:
issuing, from an AF or DRA (Diameter routing agent), an Nbsf_Management_Discovery service operation directed to the BSF for the binding record to route the Rx interface message; and
routing, from the AF or DRA, the RX interface message to the PCRF based on the binding record.

20. The method of claim 11, further comprising:
receiving the 4G communication session initiation request as a Gx interface message over a Diameter protocol.
